(19) United States
(12) Patent Application Publication
(10) Pub. No.: US 2005/0208359 A1
(43) Pub. Date: Sep. 22, 2005

(54) Fuel cell system

(75) Inventors: Yuusuke Sato, Bunkyo-ku (JP); Hiroaki Hirazawa, Inagi-shi (JP); Eiichi Sakaue, Shinagawa-ku (JP); Kei Matsuoka, Kawasaki-shi (JP); Atsushi Sadamoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/072,301

(22) Filed: Mar. 7, 2005

(30) Foreign Application Priority Data
Mar. 15, 2004 (JP) 2004-073062

(51) Int. Cl. H01M 8/04

(52) U.S. Cl. 429/34; 429/26

(57) ABSTRACT

A fuel cell system is provided with a fuel cell having an anode and a cathode; a mixing tank containing a mixture of methanol and water; a circulating flow path linking the mixing tank and the anode, the circulating flow path supplying the mixture to the anode and recycling an exhaust fluid exhausted from the anode; and a gas-liquid separator disposed on the circulating flow path, the gas-liquid separator separating a gas phase from a liquid phase of the exhaust fluid.

### CROSS-REFERENCE TO RELATED APPLICATIONS

This application is based upon and claims the benefit of priority from the prior Japanese Patent Application No. 2004-073062 (filed Mar. 15, 2004); the entire contents of which are incorporated herein by reference.

### BACKGROUND OF THE INVENTION

1. Field of the Invention

The present invention relates to a fuel cell system, which recycles water from an exhausted fluid.

2. Description of the Related Art

A direct methanol fuel cell (DMFC) is one of various types of fuel cells and capable of directly utilizing methanol as a fuel without reforming. The direct methanol fuel cell is ordinarily provided with a fuel cell stack, which includes one or more fuel cells. Each of the fuel cells is provided with a membrane electrode assembly (MEA), which is composed of a cathode catalyst layer, a cathode gas diffusion layer, an anode catalyst layer, an anode gas diffusion layer and an electrolyte membrane put between a cathode catalyst layer and an anode catalyst layer. A mixture of the methanol and water is supplied to the anode and air is supplied to the cathode. As a result of reaction in the fuel cell, water is generated and exhausted from the cathode.

The water is necessary for generating the reaction in the DMFC and for this purpose the water generated in the reaction is sometimes recycled. Japanese Patent Application Laid-open No. 2002-110199 discloses a related art, in which the water exhausted from the cathode is recycled. According to this related art, the fuel cell system is provided with a mixing tank and the recycled water and fuel supplied from a fuel tank is mixed to form a mixture therein. The recycled water contained in the mixture is supplied to the anode of the DMFC.

### SUMMARY OF THE INVENTION

According to a first aspect of the present invention, a fuel cell system is provided with a fuel cell having an anode and a cathode; a mixing tank containing a mixture of methanol and water; a circulating flow path linking the mixing tank and the anode, the circulating flow path supplying the mixture to the anode and recycling an exhaust fluid exhausted from the anode; and a gas-liquid separator disposed on the circulating flow path, the gas-liquid separator separating a gas phase from a liquid phase of the exhaust fluid.

According to a second aspect of the present invention, a fuel cell system is provided with a fuel cell having an anode and a cathode; a mixing tank supplying a mixture of methanol and water to the anode; a circulating flow path conducting an exhaust fluid exhausted from the anode; and a gas-liquid separator separating a gas phase from a liquid phase of the exhaust fluid.

### BRIEF DESCRIPTION OF THE DRAWINGS

FIG. 1 is a schematic illustration of a fuel cell system according to a first embodiment of the present invention; and

FIG. 2 is a schematic illustration of a fuel cell system according to a second embodiment of the present invention.

### DETAILED DESCRIPTION OF THE INVENTION

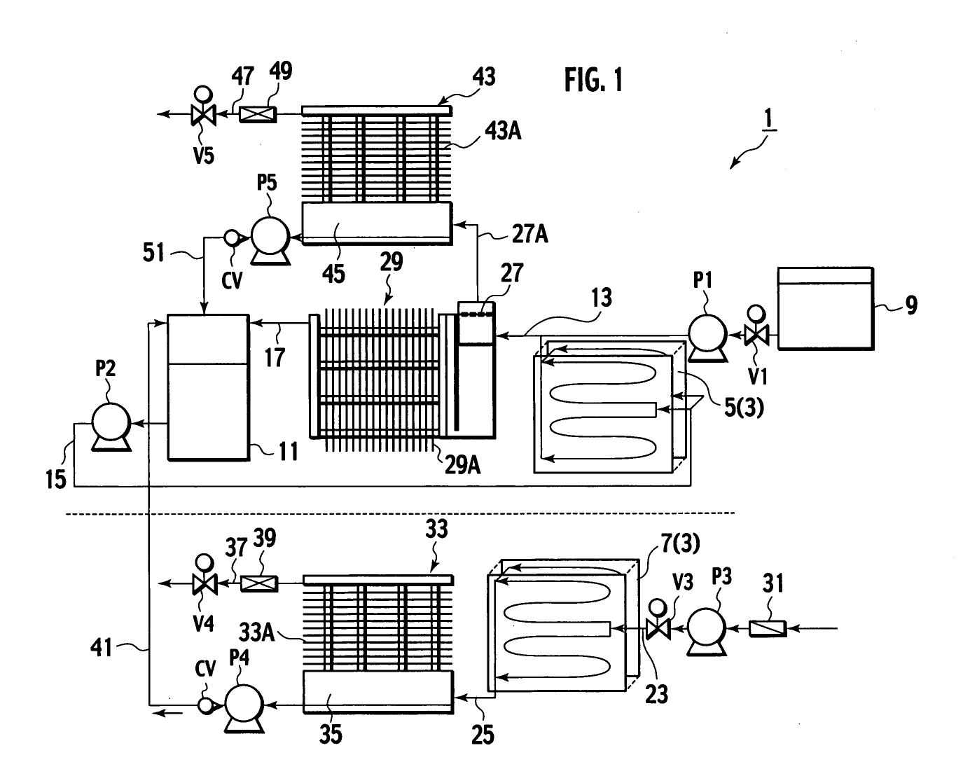

Referring now to FIG. 1, a fuel cell system 1 according to a first embodiment of the present invention is provided with a fuel cell (FC) main body 3, a fuel tank 9, a mixing tank 11, an anode-side radiator 29, a cathode side radiator 33 and an exhaust radiator 43. The FC main body 3 is composed of one or more fuel cells, each of which is provided with an anode 5, a cathode 7 and a membrane electrode assembly (MEA) interposed therebetween. The MEA is composed of a cathode catalyst layer, a cathode gas diffusion layer, an anode catalyst layer, an anode gas diffusion layer and an electrolyte membrane put between a cathode catalyst layer and an anode catalyst layer. The anode 5 and the cathode 7 are illustrated as if being separated and the MEA is omitted in FIG. 1, however, the anode 5, the MEA and the cathode 7 are closely accumulated in fact. Moreover, the fuel cell system 1 may include plural anodes 5 and plural cathodes 7, however, for ease of explanation, the following description will be given to a case where only a pair of anode 5 and cathode 7 are provided.

The fuel tank 9 contains methanol as a fuel for electricity generation. The mixing tank 11 contains a mixture of methanol and water as will be described later in detail.

A circulating flow path provided with a connection flow path 13, an outflow path 17 and a fuel supply path 15 links the fuel tank 9, the anode-side radiator 29, the mixing tank 11 and the anode 5. The connection flow path 13 links the anode 5 and the anode-side radiator 29. The fuel tank 9 is linked to the connection flow path 13 and is provided with an open-and-closable valve V1 and a pump P1 for feeding the fuel. The anode-side radiator 29 is provided with a gas-liquid separation membrane 27 disposed at a side of an outflow port of the anode 5. The outflow path 17 links the anode-side radiator 29 to the mixing tank 11. The fuel supply path 15 links the mixing tank 11 to the anode 5 and is provided with a pump P2 for feeding the mixture to the anode 5.

The methanol supplied from the fuel tank 9 is mixed with an exhaust fluid from the anode 5 in the connection flow path 13, the anode-side radiator 29 and the outflow path 17 in the course of flowing into the mixing tank 11. Thereby, unreacted methanol contained in the exhaust fluid is recycled.

The anode-side radiator 29 is provided with a plurality of radiation fins 29A, which are so dimensioned and configured to receive air fed by a ventilator (not shown in FIG. 1).

A gas-liquid separation membrane 27 is interposed between the connection flow path 13 and the anode-side radiator 29. An exhaust flow path 27A is connected to the gas-liquid separation membrane 27 and the exhaust radiator 43.

The exhaust radiator 43 is also provided with a plurality of radiation fins 43A, which are so dimensioned and configured to receive air fed by the ventilator (not shown in FIG. 1), a water collector tank 45 and an exhaust flow path 47 exposed to the exterior air.

The exhaust flow path 47 is provided with an adsorbent unit 49 for adsorbing and removing volatile organic compounds (VOC) and an open-and-closable valve V5 disposed in this order.

The water collector tank 45 is linked to the mixing tank 11 via a connection flow path 51. The connection flow path 51 is provided with a pump P5 for feeding condensed water in the water collector tank 45 to the mixing tank 11 and a check valve CV downstream thereof.

The gas-liquid separation membrane 27 separates a gas phase, which includes carbon dioxide generated at the anode 5, from a liquid phase, which includes the methanol supplied from the fuel tank 9 and the unreacted methanol and water exhausted from the anode 5, of the gas-liquid mixture fluid exhausted from the anode 5. Thereby, the carbon dioxide does not substantially flow into the anode-side radiator 29. This leads to suppression of pressure drop in an interior flow path of the anode-side radiator 29 and increase in efficiencies of heat exchange and heat radiation thereof.

The methanol supplied from the fuel tank 9 and the unreacted methanol and water are sufficiently cooled at the anode-side radiator 29. The mixing tank 11 receives the sufficiently cooled methanol and water and hence temperature increase of the fluid in the mixing tank 11 is effectively prevented. Moreover, the unreacted methanol and water can be substantially recycled so that fuel efficiency is increased.

The gas phase separated by the gas-liquid membrane 27 is cooled at the exhaust radiator 43 so as to condense condensable components such as water contained therein. The condensed water is further separated from the gas phase in the exhaust radiator 43 and collected into the water collector tank 45. The remaining gas phase is exhausted to the exterior air in a sufficiently cooled state. The condensed water is supplied to the mixing tank 11 and mixed with the methanol.

An air supply path 23 is provided so as to supply air to the cathode 7. The air supply path 23 is provided with a filter 31, an open-and-closable valve V3 and an air pump P3 disposed in this order.

The cathode 7 is linked to a cathode-side radiator 33 via a discharging flow path 25. The cathode-side radiator 33 is provided with a plurality of radiation fins 33A, which are so dimensioned and configured to receive air fed by the ventilator (not shown in FIG. 1) , a water collector tank 35 and an exhaust flow path 37 exposed to the exterior air.

The exhaust flow path 37 is provided with an adsorbent unit 39 and an open-and-closable valve V4 disposed in this order.

The water collector tank 35 is linked to the mixing tank 11 via a connection flow path 41. The connection flow path 41 is provided with a pump P4 for feeding condensed water in the water collector tank 35 to the mixing tank 11 and a check valve CV downstream thereof.

The exhaust fluid containing water vapor exhausted from the cathode 7 is cooled at the cathode-side radiator 33 so as to condense water and separate a gas phase from the exhaust fluid. The separated gas phase is exhausted to the exterior air in a sufficiently cooled state. The condensed water is supplied to the mixing tank 11 and mixed with the methanol.

Moreover, the radiators 29, 33 and 43 can radiate excessive heat generated in the fuel cell system 1.

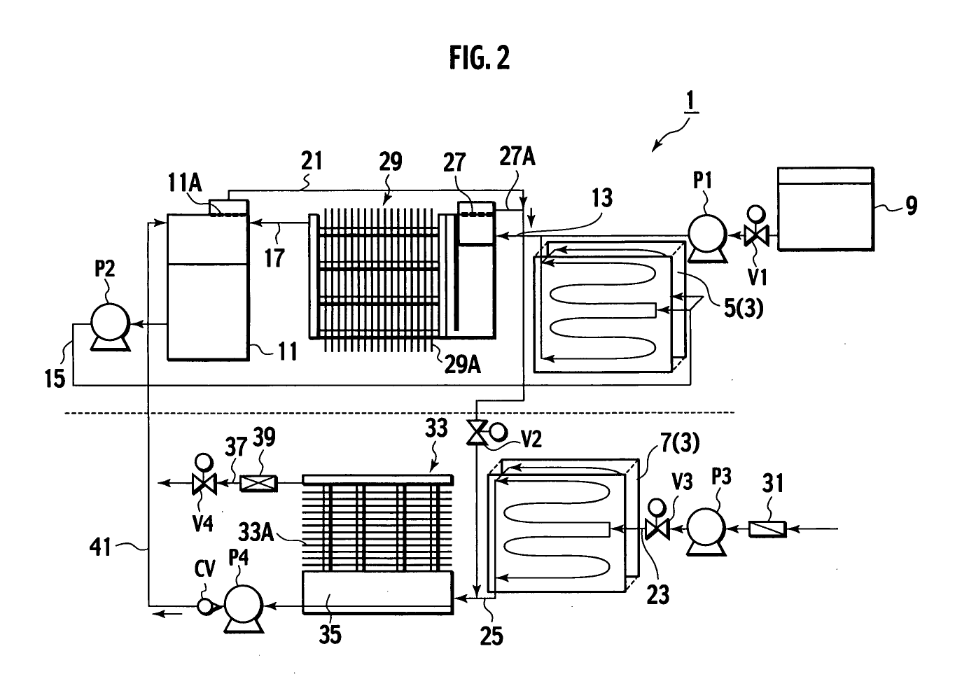

A second embodiment of the present invention will be described hereinafter with reference to FIG. 2. In this drawing and the following description, substantially the same elements as the aforementioned first embodiment are referenced with the same numerals and detailed description thereof will be omitted.

According to the second embodiment of the present invention, the mixing tank 11 is provided with a gas-liquid membrane 11A and an exhaust flow path 21 is linked thereto. The exhaust flow path 27A linked with the gas-liquid membrane 27 is merged with the exhaust flow path 21. The exhaust flow path 21 is provided with an open-and-closable valve V2 downstream of the merging portion and further merged with the discharging flow path 25 from the cathode 7.

Similarly to the aforementioned first embodiment, the gas-liquid separation membrane 27 separates a gas phase, which includes carbon dioxide generated at the anode 5, from a liquid phase, which includes methanol supplied from the fuel tank 9 and unreacted methanol and water exhausted from the anode 5, of the gas-liquid mixture fluid exhausted from the anode 5. Thereby, the carbon dioxide does not substantially flow into the anode-side radiator 29. This leads to suppression of pressure drop in an interior flow path of the anode-side radiator 29 and increase in efficiencies of heat exchange and heat radiation thereof.

The methanol supplied from the fuel tank 9 and the unreacted methanol and water are sufficiently cooled at the anode-side radiator 29. The mixing tank 11 receives the sufficiently cooled methanol and hence temperature increase of the fluid in the mixing tank 11 is effectively prevented. Moreover, the unreacted methanol can be substantially recycled so that fuel efficiency is increased.

The gas phase separated by the gas-liquid membrane 27 is cooled at the cathode-side radiator 33 so as to condense condensable components such as water contained therein. The condensed water is further separated from the gas phase in the cathode-side radiator 33 and collected into the water collector tank 35. The collected water can be conducted into the mixing tank 11 and the remaining gas phase exhausted to the exterior air in a sufficiently cooled state.

Furthermore, the exhaust fluid containing water vapor exhausted from the cathode 7 is cooled at the cathode-side radiator 33 so as to condense water and separate a gas phase from the exhaust fluid. The separated gas phase is exhausted to the exterior air in a sufficiently cooled state.

Moreover, the radiators 29 and 33 can radiate excessive heat generated in the fuel cell system 1.

According to either embodiment, when a mixture of methanol and water contained in the mixing tank 11 is supplied to the anode 5 and air is supplied to the cathode 7, an anodic reaction:
CH₃OH+H₂O→CO₂+6H⁺+6e⁻
occurs at the anode 5 and a cathodic reaction:
3/2O₂+6H⁺+6e⁻→3H₂O
occurs at the cathode 7. The methanol at the anode 5 partly crosses over to the cathode 7 and a combustion reaction thereof:
CH₃OH+3/2 O₂→CO₂+2H₂O
may occur at the cathode.

Quantities of methanol consumed by the anodic reaction per unit time (q_{MeOH}^{a}), consumed water per unit time (q_{H2O}^{a}) and generated carbon dioxide per unit time (q_{CO2}^{a}) in each cell can be represented by equations:

$$\begin{matrix}{q}_{MeOH}^{a} = ( \frac{{I}_{op}}{6 F} + \frac{{I}_{c . o .}}{6 F} ) & ( 1 ) \\ {q}_{{H}_{2} O}^{a} = ( \frac{{I}_{op}}{6 F} + \frac{{n}_{d} {I}_{op}}{F} + α ) & ( 2 ) \\ {q}_{{CO}_{2}}^{a} = \frac{{I}_{op}}{6 F} & ( 3 )\end{matrix}$$

where F is the Faraday constant, Iₒₚ is current, I_{c.o.} is proton current converted from quantity of the crossover methanol, n_{d} is a number of water molecules which one proton carries and α is a molar flux of moving water by percolation and diffusion. In a case where the FC main body 3 is composed of N fuel cells, those quantities should be multiplied by N.

Quantities of oxygen consumed by the cathodic reaction per unit time (q_{O2}^{c}), generated water per unit time (q_{H2O}^{c}) and generated carbon dioxide per unit time (q_{CO2}^{a}) in each cell can be represented by equations:

$$\begin{matrix}{q}_{{O}_{2}}^{c} = ( \frac{{I}_{op}}{4 F} + \frac{{I}_{c . o .}}{4 F} ) & ( 4 ) \\ {q}_{{H}_{2} O}^{c} = ( \frac{3 {I}_{op}}{6 F} + \frac{{n}_{d} {I}_{op}}{F} + \frac{2 {I}_{c . o .}}{6 F} + α ) & ( 5 ) \\ {q}_{{CO}_{2}}^{c} = \frac{{I}_{c . o .}}{F} & ( 6 )\end{matrix}$$

In a case where the FC main body 3 is composed of N fuel cells, those quantities should be multiplied by N.

The carbon dioxide generated by the anodic reaction forms a gas-liquid two-phase flow with a liquid exhausted from the anode 5. The two-phase flow is dissolved into the gas phase and the liquid phase by means of the gas-liquid membrane 27. Thereby, in the flow paths for the liquid phase, pressure drop of the fluid therein is suppressed since the fluid does not contain the gas phase. Moreover the flow rate of the fluid in the anode-side radiator 29 is suppressed and hence the heat-radiation efficiency of the anode-side radiator 29 is improved.

Although the invention has been described above by reference to certain embodiments of the invention, the invention is not limited to the embodiments described above. Modifications and variations of the embodiments described above will occur to those skilled in the art, in light of the above teachings.

1. A fuel cell system comprising:
a fuel cell having an anode and a cathode;
a mixing tank containing a mixture of methanol and water;
a circulating flow path linking the mixing tank and the anode, the circulating flow path supplying the mixture to the anode and recycling an exhaust fluid exhausted from the anode; and
a gas-liquid separator disposed on the circulating flow path, the gas-liquid separator separating a gas phase from a liquid phase of the exhaust fluid.

2. The fuel cell system of claim 1, further comprising a gas-liquid separation unit linked with an outflow port of the cathode, the gas-liquid separation unit separating a gas phase from an exhaust fluid from the cathode.

3. The fuel cell system of claim 2, further comprising a flow path linking the gas-liquid separator to the gas-liquid separation unit so as to merge the gas phase separated by the gas-liquid separator with the exhaust fluid from the cathode to form a mixed fluid.

4. The fuel cell system of claim 1, further comprising a radiator disposed on the circulating flow path and downstream of the gas-liquid separator, the radiator cooling the liquid phase separated by the gas-liquid separator.

5. The fuel cell system of claim 1, further comprising an exhaust radiator linked with the gas-liquid separator and the mixing tank so as to condense condensable components contained in the gas phase separated by the gas-liquid separator and feed the condensable components to the mixing tank.

6. The fuel cell system of claim 2, wherein the gas-liquid separation unit cools the exhaust fluid from the cathode so as to condense and recycle condensable components contained in the exhaust fluid.

7. The fuel cell system of claim 3, wherein the gas-liquid separation unit cools the mixed fluid so as to condense and recycle condensable components contained in the mixed fluid.

8. The fuel cell system of claim 6, further comprising a connection flow path linking the gas-liquid separation unit to the mixing tank so as to conduct the condensed condensable components to the mixing tank.

9. A fuel cell system comprising:
a fuel cell having an anode and a cathode;
a mixing tank supplying a mixture of methanol and water to the anode;
a circulating flow path conducting an exhaust fluid exhausted from the anode to the mixing tank; and
a gas-liquid separator separating a gas phase from a liquid phase of the exhaust fluid.

10. The fuel cell system of claim 9, further comprising a condenser unit condensing a liquid phase from an exhaust fluid from the cathode.

11. The fuel cell system of claim 10, further comprising a flow path merging the gas phase separated by the gas-liquid separator with the exhaust fluid from the cathode to form a mixed fluid.

12. The fuel cell system of claim 9, further comprising a radiator cooling the liquid phase flowing in the circulating flow path.

13. The fuel cell system of claim 9, further comprising an exhaust radiator cooling the gas phase separated by the gas-liquid separator so as to condense and feed condensable components contained therein to the mixing tank.

14. The fuel cell system of claim 10, wherein the condenser unit condenses condensable components contained in the exhaust fluid from the cathode.

15. The fuel cell system of claim 11, wherein the condenser unit condenses condensable components contained in the mixed fluid.

16. The fuel cell system of claim 14, further comprising a connection flow path conducting the condensable components condensed by the condenser unit from the condenser unit to the mixing tank.
